(19) United States
(12) Patent Application Publication
(10) Pub. No.: US 2024/0405830 A1
(43) Pub. Date: Dec. 5, 2024

(54) BEAMFORMING SOLUTION FOR MIMO COMMUNICATION

(71) Applicant: NOKIA SOLUTIONS AND NETWORKS OY, Espoo (FI)

(72) Inventors: Nuan SONG, Shanghai (CN); Stefan WESEMANN, Kornwestheim (DE); Olli Juhani PIIRAINEN, Oulu (FI); Rana Ahmed SALEM, Munich (DE); Tao YANG, Shanghai (CN); Yan ZHAO, Shanghai (CN)

(21) Appl. No.: 18/699,432

(22) PCT Filed: Oct. 25, 2021
(86) PCT No.: PCT/CN2021/126206

§ 371 Date: Apr. 8, 2024

(51) Int. Cl. H04B 7/06

(52) U.S. Cl. CPC H04B 7/0634; H04B 7/0639

(57) ABSTRACT

Embodiments of the present disclosure relate to a beamforming solution for MIMO communication. The method implemented at a first device comprises: obtaining: a signature vector corresponding to a beam which is in a first direction from the first device to a second device, and a first channel covariance matrix associated with a transmission from the first device to the second device. The method further comprises generating, based on the signature vector and the first channel covariance matrix, a beamforming matrix to be used for the transmission from the first device to the second device. In this way, the accuracy of the beamforming matrix is improved and the calculation amount for the beamforming matrix is reduced.

### FIELD

Embodiments of the present disclosure generally relate to the field of telecommunication and in particular, to a beamforming solution for a multiple input multiple output (MIMO) system.

### BACKGROUND

In order to meet the increasing wireless data traffic demand, a plurality of schemes have been proposed and implemented, where the MIMO technology is considered as one powerful scheme to achieve high data throughputs in the communication system. MIMO refers to the type of wireless transmission and reception scheme where both a transmitter and a receiver employ more than one antenna. A MIMO system may take advantage of the spatial diversity or spatial multiplexing to improve the signal-to-noise ratio (SNR) and increases throughput.

Massive MIMO is a type of MIMO system with a very large number of antennas (for example, greater than an 8×8 array). Further, massive MIMO combined with beamforming can deliver a high spatial multiplexing gain and a large beamforming gain, which is considered as one key feature of the fifth generation (5G) new radio (NR) to enhance the system spectral efficiency. In the massive MIMO system, the transmitter may use a beamforming matrix to perform related transmission. As a result, it is desirable to improve the accuracy of the beamforming matrix and reduce the calculation amount for generating the beamforming matrix.

### SUMMARY

In general, example embodiments of the present disclosure provide a beamforming solution for a MIMO system.

In a first aspect, there is provided a first device. The first device comprises: at least one processor; and at least one memory including computer program codes. The at least one memory and the computer program codes are configured to, with the at least one processor, cause the first device to: obtain: a signature vector corresponding to a beam which is in a first direction from the first device to a second device, and a first channel covariance matrix associated with a transmission from the first device to the second device; and generate, based on the signature vector and the first channel covariance matrix, a beamforming matrix to be used for the transmission from the first device to the second device.

In a second aspect, there is provided a method performed by a first device. The method comprises: obtaining: a signature vector corresponding to a beam which is in a first direction from the first device to a second device, and a first channel covariance matrix associated with a transmission from the first device to the second device; and generating, based on the signature vector and the first channel covariance matrix, a beamforming matrix to be used for the transmission from the first device to the second device.

In a third aspect, there is provided a first apparatus. The first apparatus comprises: means for obtaining: a signature vector corresponding to a beam which is in a first direction from the first apparatus to a second apparatus, and a first channel covariance matrix associated with a transmission from the first apparatus to the second apparatus; and means for generating, based on the signature vector and the first channel covariance matrix, a beamforming matrix to be used for the transmission from the first apparatus to the second apparatus.

In a fourth aspect, there is provided a non-transitory computer readable medium. The non-transitory computer readable medium comprises program instructions for causing an apparatus to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a signaling flow of a proposed solution for a beamforming procedure;

FIG. 2 illustrates an example communication network in which example embodiments of the present disclosure may be implemented;

FIG. 3 illustrates a signaling flowchart illustrating an example method for performing a beamforming procedure according to some embodiments of the present disclosure;

FIG. 4A illustrates a signaling flow illustrating an example process for determining the related beam(s) to some embodiments of the present disclosure;

FIG. 4B illustrates a signaling flow illustrating another example process for determining the related beam(s) according to some embodiments of the present disclosure;

FIG. 5A illustrates a signaling flow illustrating an example process for obtaining the signature vector according to some embodiments of the present disclosure;

FIG. 5B illustrates a signaling flow illustrating an another process for obtaining the signature vector according to some embodiments of the present disclosure;

FIGS. 6A and 6B illustrates the simulation results;

FIG. 7 illustrates the computational complexity curves;

FIG. 8 illustrates a signaling flow of an example method performed by the first device according to some embodiments of the present disclosure;

FIG. 9 illustrates a simplified block diagram of an apparatus that is suitable for implementing example embodiments of the present disclosure; and

FIG. 10 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As discussed above, massive MIMO combined with beamforming can deliver a high spatial multiplexing gain and a large beamforming gain. Currently, the MIMO system is usually proposed to be implemented with a two-stage transmission scheme including precoding procedure and beamforming procedure, where the beamforming procedure acts as reduced-rank filtering to reduce the overhead of the channel state information (CSI) feedback, to enhance the array gain, and to lower the complexity of precoding.

Further, different schemes have been proposed for implementing the beamforming procedure. One scheme for implementing the beamforming procedure is Grid of Beams (GoB), where the network device selects the strongest beams from the GoB for the terminal device. Another scheme for implementing the beamforming procedure is user-specific Eigen Beam Forming (EBF), where the network device designs beam(s) for each user to maximize the signal strength. Generally speaking, it is considered that the user-specific EBF may achieve an improved performance compared with GoB scheme.

Further, in 5G NR communication system, a class of advanced CSI codebooks was specified which relies on exploiting frequency division duplexing (FDD) reciprocity in spatial domain, namely the port selection codebook and enhanced port selection codebook (defined in release 16). In both of the above codebooks, the network device applies spatial beamforming on reference signals (RSs), such as, CSI-RS, and the terminal device would select a subset of the beams depending on the measured aggregated channel.

Currently, the third generation partnership project (3GPP) identified that further improvements can be achieved by exploiting partial uplink and downlink channel reciprocity. In 3GPP release 17, work on CSI enhancements for 5G NR continues. In the description of the work item “Further enhancements on MIMO for NR”, one topic is to evaluate and, if needed, specify CSI reporting for DL multi-TRP and/or multi-panel transmission to enable more dynamic channel/interference hypotheses for non-coherent joint transmission (NCJT), targeting both frequency range 1 (FR1) and frequency range 2 (FR2). Another topic is to evaluate and, if needed, specify type II port selection codebook enhancement (based on release 15/16 type II port selection) where information related to angle(s) and delay(s) are estimated at the gNB based on uplink sounding reference signal (SRS) by utilizing downlink/uplink (DL/UL) reciprocity of angle and delay, and the remaining DL CSI is reported by the UE. This may provide better trade-off among UE complexity, performance and reporting overhead, especially in FDD FR1 environment.

Current FDD MIMO products based on a GoB solution still need performance enhancements and EBF is considered as one potential feature for next FDD MIMO products. To implement EBF in FDD, information on a DL channel is required at a network device. Unlike time division duplexing (TDD) where channel reciprocity holds, CSI measured from an UL channel in FDD cannot be directly applied to DL beamforming design. The DL beamforming design has to rely on CSI feedback from a terminal device, which will lead to a very large overhead. Therefore, the key problem to be solved is how to take advantages of partial reciprocity to design the downlink beamforming from the uplink measurements, providing an enhanced performance compared to downlink GoB and reducing the feedback overhead.

In addition to the above, in the sixth generation (6G) communication, in order to achieve an even higher data rate and ensure a wide coverage, extreme large antenna arrays and a wide bandwidth (about 500 MHz) are desired at higher frequencies, for example, about 512 radio units at 7 GHz. Further, in the 6G system, very large antenna arrays impose significant computational efforts on beamforming. Moreover, due to the wide bandwidth, there might be asymmetric UL and DL bandwidth/coverage requirements. The channel information acquired in the UL may only lie in a certain sub-band to ensure the coverage but the DL transmission would lie in a different band or a larger band. In this case, even for TDD, imperfect reciprocity will occur. Therefore, the operations of frequency compensation or the channel estimation seem to be necessary. It is expected that the beamforming design may be implemented with low-complexity implementations on the field programmable gate arrays (FPGA)/system-on-a-chip (SoC) especially for very large arrays and solve the imperfect reciprocity between UL and DL due to a wide bandwidth.

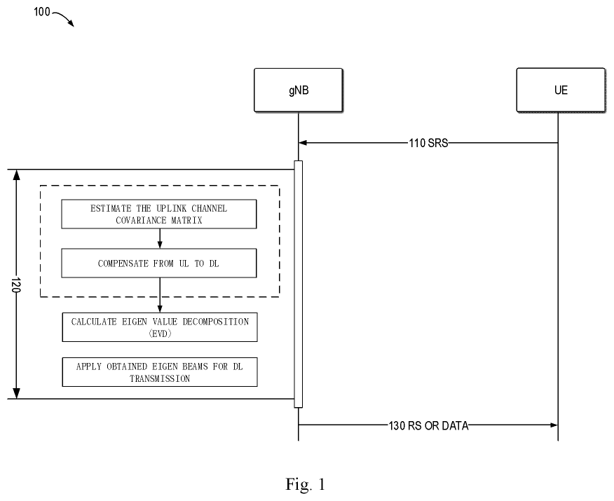

Recently, channel reciprocity between UL and DL has been investigated for FDD and the investigation shows that partial reciprocity can be utilized in FDD for MIMO enhancements. Reference is now made to FIG. 1, which illustrates a signaling flow 100 of a proposed solution for beamforming procedure. As illustrated in FIG. 1, the UE transmits SRS to the gNB, and the gNB performs 120 a beam forming procedure based on the received SRS. Specifically, the gNB estimates the UL channel covariance matrix and transforms/compensates the UL channel covariance matrix to generate a compensated channel covariance matrix for DL by using the FDD partial reciprocity on the angles. Then, the gNB calculates/applies Eigen Value Decomposition (EVD) and obtain the eigen beams. Next, the gNB applies the obtained eigen beams for DL transmission. For example, the gNB transmits 130 the RS or the data to the UE.

In the above proposed solution, the computational complexity of EVD is quite high, especially for a larger number of radio units. In other proposed solution where the EVD is implemented with a low-complexity, many iteration procedures are required and the orthogonalization procedure is needed for each iteration procedure, which causes that the computational complexity is still very high. In addition, in these proposed solutions, the eigen beams for DL transmission are derived purely based on the uplink channel covariance matrix, which causes that such solution may only works in the case where perfect angular reciprocity exists. However, as discussed above, in the actually communication scenario, the imperfect reciprocity scenario is more common, which causes that the above proposed solutions cannot work well in in practice.

In order to solve the above and other potential problems, embodiments of the present disclosure provide a solution for beam forming. In the solution, in addition to taking account the channel covariance matrix, the first device also considers a signature vector corresponding to a beam which is in the first direction (i.e., from the first device to the second device) when generating the beamforming matrix to be used for a transmission from the first device to the second device. In this way, the accuracy of the beamforming matrix is improved and the calculation amount for the beamforming matrix is reduced as no EVD is required. As a result, the impacts caused by imperfect UL/DL reciprocity in both TDD and FDD may be reduced.

Some example embodiments of the present disclosure will now be described in detail with reference to the figures. However, those skilled in the art would readily appreciate that the detailed description given herein with respect to these figures is for explanatory purpose as the present disclosure extends beyond theses limited embodiments.

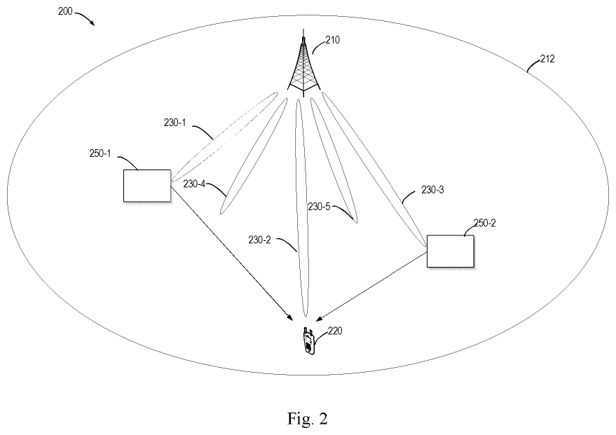

FIG. 2 shows an example communication environment 200 in which example embodiments of the present disclosure can be implemented. In the communication environment 200, a first device 210 can communicate with a second device 220 via physical communication channels or links. Further, the first device 210 may communicate with the second device 220 via different beams to enable a directional communication. In the example of FIG. 2, beams 230-1 to 230-5 are illustrated. For purpose of discussion, the beams 230-1 to 230-5 are collectively or individually referred to as beam 230. Further, although not shown, the second device 220 also supports to use a plurality of beams to communicate with the first device 210.

In the environment 200, if the first device 210 is a network device and the second device 220 is a terminal device (i.e. UE), a link from the second device 220 to the first device 210 is referred to as UL, while a link from the first device 210 to the second device 220 is referred to as a DL. In DL, the first device 210 is a transmitting (TX) device (or a transmitter) and the second device 220 is a receiving (RX) device (or a receiver), and the first device 210 may transmit DL transmission to the second device 220 via one or more beams. As illustrated in FIG. 2, the first device 210 transmits DL transmission to the second device 220 via the beams 230-1 to 230-3. In UL, the first device 210 is a RX device (or a receiver) and the second device 220 is a TX device (or a transmitter). In the specific example of FIG. 2, the second device 220 is served by the first device 210 and located in the cell 212 provided by the first device 210.

The communications in the environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the 5G and 6G communication protocols.

It is to be understood that the numbers their connections of first device, second device, beam and cell, and are only for the purpose of illustration without suggesting any limitations. The communication environment 100 may include any suitable first device, second device, beam and cell adapted for implementing embodiments of the present disclosure. Although not shown, it is to be understood that one or more additional first devices and second devices may be located in the respective cells. It would also be appreciated that in some examples, only the homogeneous network deployment or only the heterogeneous network deployment may be included in the environment 200.

In the following text, example embodiments where the first device 210 is a network device and the second device 220 is a terminal device are described merely for illustration purpose and without suggesting any limitations as to the scope of the present disclosure. It is to be understood that, in other embodiments, the first device 210 may be a terminal device and the second device 220 may be a network device. In other words, the principles and spirits of the present disclosure can be applied to both UL and DL transmissions.

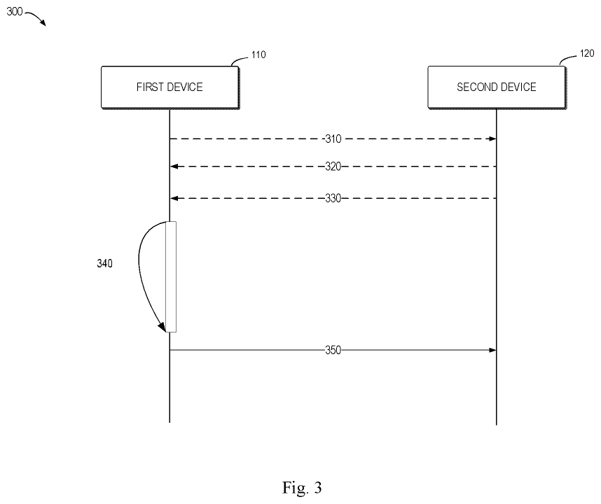

Example embodiments of the present disclosure will be described in detail below with reference to FIGS. 3-5B.

For ease of discussion, some terms used in the following description are listed as below:
first direction: a direction from the first device 210 to the second device 220, also referred to as DL direction sometimes;
second direction: a direction from the second device 220 to the first device 210, also referred to as UL direction sometimes;
first channel covariance matrix: associate with a transmission from the first device 210 to the second device 220, be referred to as “compensated channel covariance matrix sometimes and be represented as R_{UL,c};
second channel covariance matrix: be determined from a reference signal (RS), such as SRS, be referred to as “uplink channel covariance matrix” sometimes and be represented as R_{UL};
signature vector: correspond to a beam which is in the first direction, and be represented as a_{DL} or a_{UL,c}; and
beamforming matrix: be used for the transmission from the first device 210 to the second device 220 and be represented as W.

Reference is now made to FIG. 3, which shows a signaling flow 300 for beamforming according to some example embodiments of the present disclosure. For the purpose of discussion, the signaling flow 300 will be described with reference to FIG. 2. The signaling flow 300 may involve a first device 210 and a second device 220. In the signaling flow 300, the first device 210 is a serving device (such as, a network device) of the second device 220 (such as, a terminal device).

In operation, the first device 210 needs to perform a beamforming-based transmission to the second device 220. In this event, the first device 210 determines 340 related beam(s), and then performs 350 the beamforming-based transmission to the second device 220.

According to the example embodiments of the present disclosure, the procedure for performing beamforming (especially for the processes of determining the related beam(s) for the transmission from the first device 210 to the second device 220) is improved.

In some embodiments, the first device 210 obtains a signature vector and a first channel covariance matrix first, and then generates a beamforming matrix to be used for the transmission from the first device 210 to the second device 220 based on the signature vector and the first channel covariance matrix, where the signature vector corresponds to a beam which is in the first direction from the first device 210 to a second device 220 and the first channel covariance matrix (also be referred to as “downlink channel covariance matrix” sometimes, and be represented as “R_{UL,c}”) is associated with a transmission from the first device 210 to the second device 220.

Compared with the conventional solutions which merely relaying on a covariance matrix determined from the SRS transmission and an EVD, according to the example embodiments of the present disclosure, in addition to taking account the channel covariance matrix, a signature vector corresponding to a beam which is in the first direction is also considered when generating the beamforming matrix. In this way, the accuracy of the beamforming matrix is improved and the calculation amount for generating the beamforming matrix is reduced as no EVD is required. Moreover, the impact caused by the imperfect reciprocity is further reduced. The products of MIMO including both FDD MIMO and TDD MIMO with a large wideband will benefit from the present disclosure.

In the following text, the example processes for obtaining the signature vector and the first channel covariance matrix will be discussed in detail. First, the example processes for obtaining the first channel covariance matrix will be discussed.

In some example embodiments, the first device 210 receives a RS from the second device 220, and determines a second channel covariance matrix (also be referred to as “uplink channel covariance matrix” sometimes, and be represented as “R_{UL}”) based on the RS. Then, the first device 210 obtains the first channel covariance matrix R_{UL,c} by transforming the second channel covariance matrix R_{UL}.

In one specific example embodiment, the first device 210 revives SRS for the second device 220 and calculates a second channel covariance matrix R_{UL} based on the SRS.

In some example embodiments, the second channel covariance matrix R_{UL} is determined as shown in equation (1) below.

$${R}_{U L} = \frac{1}{{N}_{t} {N}_{f} {N}_{p o l}} {{\sum }_{{n}_{t} = 1}}^{{N}_{t}} {{\sum }_{{n}_{f} = 1}}^{{N}_{f}} {{\sum }_{{n}_{p} = 1}}^{{N}_{pol}} {H}_{U L}^{H} ( {n}_{t} , {n}_{f} , {n}_{p} ) {H}_{U L} ( {n}_{t} , {n}_{f} , {n}_{p} ) \qquad ( 1 )$$

where H_{UL}(nₜ, n_{f}, nₚ)∈C^{M}^{ᵣ}^{×M}^{_{f}}, is the channel in the second direction (i.e., form the second device 220 to the first device 210) between the second device 220 with Mᵣ antennas and the first device 210 with M_{T}=MₜNₚₒₗ antennas at the time slot nₜ, the frequency carrier n_{f}, and the nₚ-th polarization.

It should be understood that the above example embodiments for the second channel covariance matrix R_{UL} are illustrated only for the purpose of illustration without suggesting any limitations. In other example embodiments, the second channel covariance matrix R_{UL} may be determined from any suitable signal(s) from the second device 220 and according to any suitable rule which is not limited to the above equation (1). The present disclosure is not limited in this regard.

Additionally, in some example embodiments, the second channel covariance matrix R_{UL} is calculated based on long-term channels. Alternatively, in some other example embodiments, the second channel covariance matrix R_{UL} is calculated based on short-term channels.

As discussed above, according to the example embodiments of the present disclosure, the first channel covariance matrix R_{UL,c} is transformed from the second channel covariance matrix R_{UL}. In one specific example embodiments, the first device 210 compensates a frequency duplex distance between the first direction and the second direction to achieving the transformation from the second channel covariance matrix R_{UL} to the first channel covariance matrix R_{UL,c}.

In the specific example embodiment where the first device 210 is a network device, the first device 210 carries out a covariance transformation of an uplink covariance matrix (i.e., the second channel covariance matrix), and obtains the compensated uplink channel covariance matrix (i.e., the first channel covariance matrix), i.e., to transform the uplink channel covariance matrix for the downlink use, by compensating the frequency duplex distance between the uplink and downlink in FDD.

In some example embodiments, the covariance transformation process may be the dominant angle or generalized angle based transformation mechanism, which may be implemented by a current mechanism.

In one specific example embodiment, the first channel covariance matrix R_{UL,c} is determined as shown in equation (2) or equation (3) below.

$${R}_{U L , c} = T ( {θ}_{max} ) {R}_{U L} {T}^{H} ( {θ}_{max} ) \qquad ( 2 )$$

$${R}_{UL , c} = \frac{1}{r} {\sum }_{m = 1}^{r} T ( {θ}_{m} ) {R}_{U L} {T}^{H} ( {θ}_{m} ) \qquad ( 3 )$$

where θₘₐₓ is the maximum DoA and r represents the number of angles to be used for transformation. The transformation matrix T(θ) is diagonal and calculated by array responses in the first direction (such as, uplink) and the second direction (such as, downlink). In one specific example embodiments, the transformation matrix T(θ) is determined as shown in equation (4) below.

$${[ T ( θ ) ]}_{n n} = \frac{{[ {a}_{D L} ( θ ) ]}_{n}}{{[ {a}_{U L} ( θ ) ]}_{n}} \qquad ( 4 )$$

where [T(θ)]ₙₙ denotes the n-th row, n-th column of the matrix T(θ), [a_{DL}(θ)]ₙ denotes the n-th element of the vector a_{DL}(θ), and [α_{UL} (θ)]ₙ denotes the n-th element of the vector α_{UL} (θ). Further, vector a_{DL}(θ) and vector α_{UL} (θ) are corresponding to a vector in the first direction (DL) and a vector in the second direction (UL) at angle θ, respectively.

In another specific example embodiment, neural network based transformation is used for implementing the covariance transformation process.

It should be understood that the above example covariance transformation processes are illustrated only for the purpose of illustration without suggesting any limitations. In other example embodiments, any suitable covariance transformation processes may be used for implementing the transformation from the second channel covariance matrix to the first channel covariance matrix. The present disclosure is not limited in this regard.

According to the above descriptions, the first device 210 may determine the first channel covariance matrix R_{UL,c}. In the following, the processes for obtaining the signature vector will be discussed.

In some example embodiments, the signature vector is obtained based on an indicated dominant beam, where the signature vector is represented as a_{DL}. In the specific example embodiment of FIG. 3, the first device 210 transmits 310 signals to be measured to the second device 220. One example of the signals is a Synchronization Signal Block (SSB) signal. Another example of the signals is a RS, such as, CSI-RS. In other example embodiments, other suitable signals may be transmitted to the second device 220. Based on the transmitted signals, the second device 220 may determine a dominant beam in the first direction.

In some example embodiments, the first device 210 generates beams (be represented as [symbol] =[w₀, . . . , w_{L}]∈C^{M}^{_{T}}^{×L}) to sweep over the wide spatial area. In one example embodiment, the beams are obtained from a pre-defined codebook. Alternatively, in another example embodiment, the beams are the self-calculated beams. Additionally, in case that the first device 210 is a network device, the beams may be either cell-specific or UE-specific.

Next, the first device 210 applies those beams [symbol] =[w₀, . . . , w_{L}]∈C^{M}^{_{T}}^{×L} and transmits beamformed signals (such as, SSB or CSI-RS) to the second device 220. The second device 220 measures the received beamformed signals (be represented by y_{DL}=H_{DL}wₗs_{DL}+n, l=1, . . . , L, where ‘H_{DL}’ is the downlink channel, s_{DL} is the transmitted signal and n is the noise signal) and determines the dominant beam which delivers the highest power. In one example embodiment, at the second device 220, the signature vector corresponding to the dominant beam may be determined by

$${a}_{D L} = {max}_{{w}_{l} , l = 1 … , L} ‖ {y}_{D L} ‖ = {max}_{{w}_{l} , l = 1 … , L} ‖ {H}_{DL} {w}_{l} {s}_{D L} + n ‖ ,$$

where ∥⋅∥ denotes the 2-norm operation. In some example embodiments, the second device 220 transmits 320 information about the dominant beam to the first device 210, and the first device 210 obtains the signature vector a_{DL} based on the indicated dominant beam.

In some example embodiments, the first device 210 may determine the beamforming matrix based on the signature vector a_{DL} and the first channel covariance matrix R_{UL,c} according to the below equation (5).

$$W = [ {a}_{D L} , {R}_{UL , c} {a}_{D L} , … {R}_{U L , c}^{r - 1} {a}_{D L} ] \qquad ( 5 )$$

It should be understood that the above equation (5) for determining the beamforming matrix is illustrated only for the purpose of illustration without suggesting any limitations. In other example embodiments, the beamforming matrix W may be determined based on any suitable calculation relationship between the signature vector a_{DL} and the first channel covariance matrix R_{UL,c}. The present disclosure is not limited in this regard.

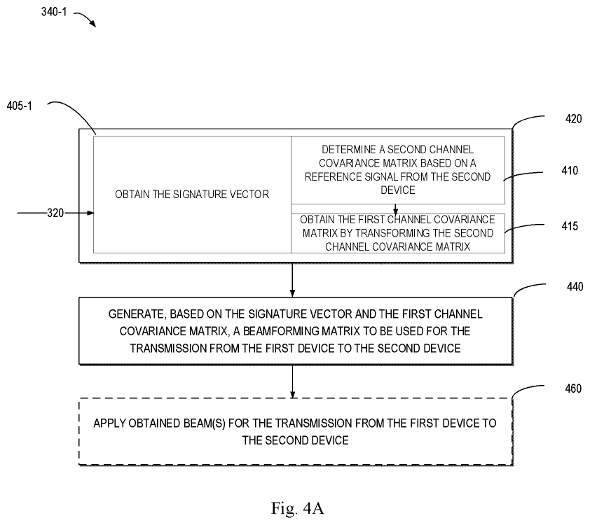

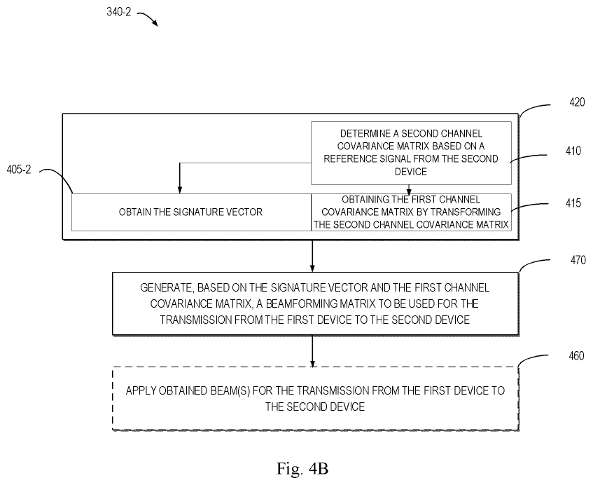

One example process for performing the beamforming procedure is discussed with reference to FIG. 4A. FIG. 4A illustrates a signaling flow illustrating another example process 340-1 for determining the related beam(s) according to some embodiments of the present disclosure.

At block 420, the first device 210 obtains the signature vector a_{DL} and the first channel covariance matrix R_{UL,c}. Specifically, at block 410, the first device 210 determines a second channel covariance matrix R_{UL} based on a RS from the second device 220. Then, at block 415, the first device 210 obtains the first channel covariance matrix R_{UL,c} by transforming the second channel covariance matrix R_{UL}. Independently, at block 405-1, the first device 210 obtains the signature vector a_{DL} based on information about the dominant beam in the first direction.

Next, at block 440, the first device 210 generates the beamforming matrix W to be used for the transmission from the first device 210 to the second device 220 based on the signature vector a_{DL} and the first channel covariance matrix R_{UL,c}.

At block 460, the first device 210 may apply the obtained beam(s) for the transmission from the first device 210 to the second device 220. In some example embodiments, one orthogonalization procedure for multiple beams in matrix W is required. In one specific example embodiment, the Gram-Schmidt orthogonalization may be carried out. In other example embodiments, any suitable orthogonalization scheme may be carried out.

It can be seen, in the above example processes, a hybrid of two directions (downlink/uplink) concept is applied, especially, the first device 210 may determine the signature vector from the information about the dominant beam, which more accurately reflects the characters for the transmission from the first device 210 to the second device 220. Further, such information about the dominant beam is common feedback information in conventional communication procedure. As a result, the above example processes do not require additional information exchanging procedure between the first device 210 and the second device 220.

Alternatively, in some other example, the first device 210 may obtain the signature vector from the second channel covariance matrix (or the channel covariance matrix transformed from the second channel covariance matrix). In other words, the first device 210 may obtain the signature vector from the second channel covariance matrix. In this event, the signature vector is represented as a_{UL,c}.

In some example embodiments, the first device 210 may determine the beamforming matrix W based on the signature vector a_{UL,c} and the first channel covariance matrix R_{UL,c} according to the below equation (6).

$$W = [ {a}_{UL , c} , {R}_{UL , c} {a}_{UL , c} , … {R}_{U L , c}^{r - 1} {a}_{U L , c} ] \qquad ( 6 )$$

It should be understood that the above example equation (6) for determining the beamforming matrix are illustrated only for the purpose of illustration without suggesting any limitations. In other example embodiments, the beamforming matrix may be determined based on any suitable calculation relationship between the signature vector a_{UL,c} and the first channel covariance matrix R_{UL,c}. The present disclosure is not limited in this regard.

One example process for performing the beamforming procedure is discussed with reference to FIG. 4B. FIG. 4B illustrates a signaling flow illustrating another example process 340-2 for determining the related beam(s) according to some embodiments of the present disclosure. In the same element in FIGS. 4A and 4B are used the same reference number. Merely for brevity, the same or similar descriptions are omitted here.

At block 420, the first device 210 obtains the signature vector a_{UL,c} and the first channel covariance matrix.

Specifically, at block 405-2, the first device 210 obtaining the signature vector a_{UL,c} from the second channel covariance matrix R_{UL}. Descriptions about blocks 410 and 415 are omitted here.

Next, at block 440, the first device 210 generates the beamforming matrix W to be used for the transmission from the first device 210 to the second device 220 based on the signature vector a_{UL,c} and the first channel covariance matrix R_{UL,c}, such as according to the above equation (6).

At block 460, the first device may apply the obtained beams for the transmission from the first device 210 to the second device 220.

It can be seen, in the above processes, a signal direction (such as, uplink) concept is applied. In these example embodiments, by using both the signature vector and the first channel covariance matrix to generate the beamforming matrix, the accuracy of the beamforming matrix is improved and the calculation amount for the beamforming matrix is reduced.

In the following, processes about how to determine the signature vector a_{UL,c} from the second channel covariance matrix R_{UL} will be discussed in detail.

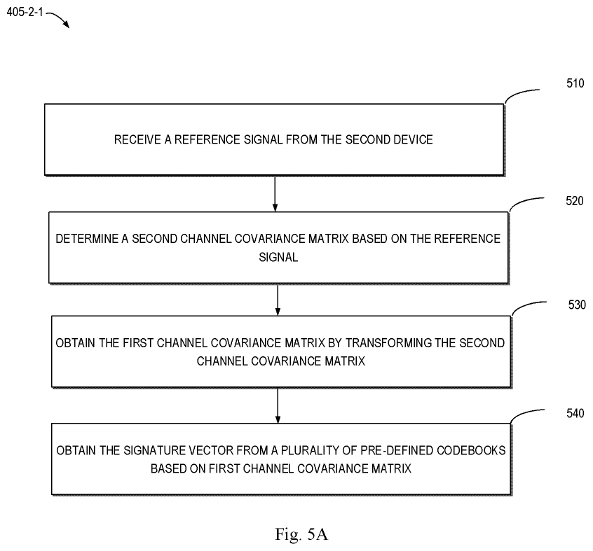

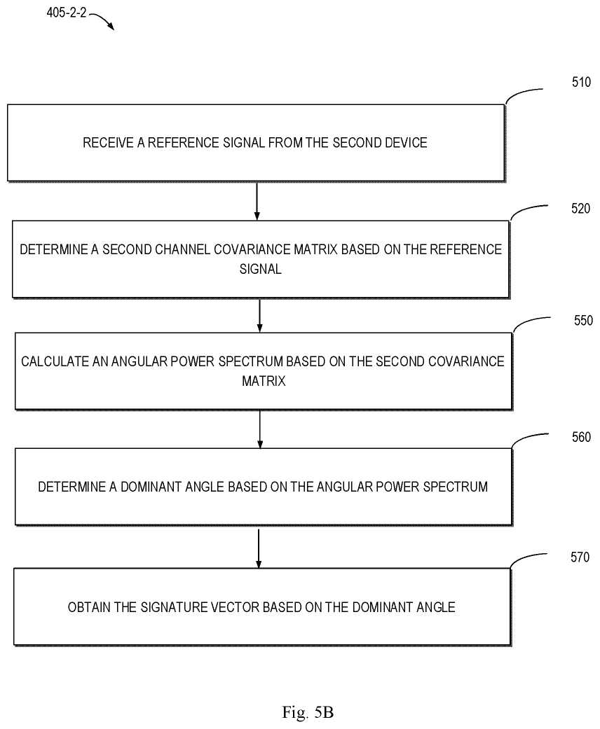

Reference is now made to FIG. 5A, which illustrates a signaling flow illustrating an example process 405-2-1 for obtaining the signature vector a_{UL,c} according to some embodiments of the present disclosure. When discussing FIG. 5A, the processes for determining the first channel covariance matrix R_{UL,c} and the second channel covariance matrix R_{UL} are the same as discussed in the present disclosure. Merely for brevity, the same or similar descriptions are omitted here.

At block 510, the first device 210 receives RS from the second device 220. Then, at block 520, the first device 210 determines the second channel covariance matrix R_{UL}. Next, at block 530, the first device 210 obtains the first channel covariance matrix R_{UL,c} by transforming the second channel covariance matrix R_{UL}.

At block 540, the first device obtains the signature vector a_{UL,c} from a plurality of pre-defined codebooks based on first channel covariance matrix R_{UL,c}. In one example embodiment, the signature vector is determined by

$${a}_{U L , c} = {max}_{{w}_{l} , l = 1 … , L} {w}_{l}^{H} {R}_{U L , c} {w}_{i} ,$$

where w₁∈ [symbol] =[w₀, . . . , w_{L}]∈C^{M}^{_{T}}^{×L} and corresponds to a beam in the first direction.

Another example embodiment for determining the signature vector a_{UL,c} from the second channel covariance matrix R_{UL} will be discussed with reference to FIG. 5B. FIG. 5B illustrates a signaling flow illustrating an example process 405-2-2 for obtaining the signature vector a_{UL,c} according to some embodiments of the present disclosure.

In the same element in FIGS. 5A and 5B are used the same reference number. Merely for brevity, the same or similar descriptions are omitted here.

At block 550, the first device 210 calculates an angular power spectrum based on the second channel covariance matrix R_{UL}. At block 560, the first device 210 determines dominant angle θₘₐₓ based on the angular power spectrum.

Then, at block 570, the first device 210 obtains the signature vector a_{UL,c} based on the determined dominant angle. Specifically, based on the partial reciprocity in FDD, where θₘₐₓ is reciprocal for both UL and DL, the signature vector a_{UL,c} can be obtained based on the downlink array response at the angle θₘₐₓ, represented by a_{UL,c}=a_{DL}(θₘₐₓ).

In this way, the signature vector a_{UL,c} may be obtained. It should be understood that the above examples for determining the signature vector a_{UL,c} are illustrated only for the purpose of illustration without suggesting any limitations. In other example embodiments, the signature vector a_{UL,c} may be determined based on any suitable manner. The present disclosure is not limited in this regard.

In this way, by using the signature vector (a_{DL} or a_{UL,c}), the accuracy of the beamforming matrix is improved and the calculation amount for the beamforming matrix is reduced.

### Simulation Results

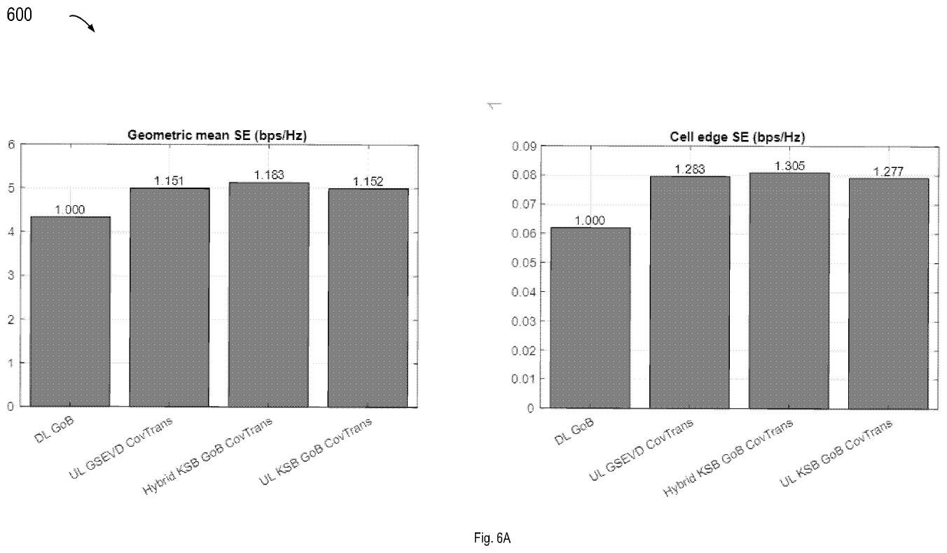

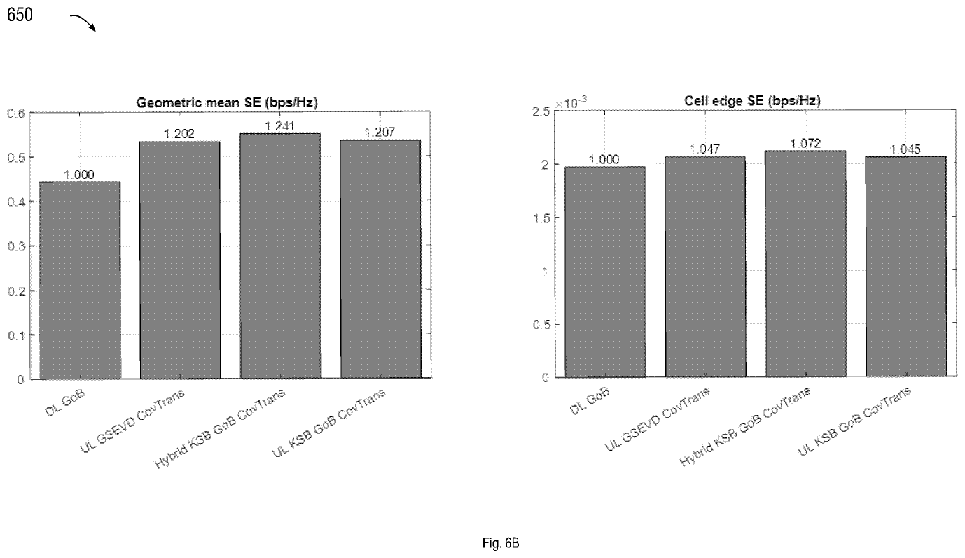

In the following, the performance of the present disclosure for the beamforming function is evaluated by comparing the present disclosure with different conventional solutions, where zero-forcing precoding is considered for all the cases. FIGS. 6A and 6B illustrates the Simulation results 600 and 650. The legends with “DL” and “UL” refer to the algorithms that are simulated using the DL or UL channels, respectively. The “DL GoB” is the current GoB based MIMO solution using the discrete Fourier transform (DFT) DFT codebook with an oversampling factor 4. The “UL GSEVD CovTrans” is a low-complexity power iterative EBF method using the compensated uplink channel covariance matrix for multi-beam calculations in one conventional solution, where the number of iterations of 4 is chosen. The “UL KSB GoB CovTrans” refers to one of the solution of the present disclosure where the signature vector a_{UL,c} is obtained by the compensated UL channel covariance matrix, by choosing the beam from the DFT codebook with an oversampling factor 4. The “Hybrid KSB GoB CovTrans” is the solution, where the signature vector a_{DL} is fed back from UE (selected from the DFT codebook with an oversampling factor 4) and the compensated uplink covariance matrix is applied. The channel parameters as well as the array geometry used are listed in Table 1.

TABLE 1
An Example of Simulation Parameters
Simulation Parameters

| | |
|---|---|
| Channel model | sub-6 GHz in 3GPP TR 38.901 |
| Scenario | NR-Umi/Uma |
| Carrier frequency (DL/UL) | 2.15 GHz/1.75 GHz |
| Bandwidth | 20 MHz |
| BS Tx Antenna | 192 AEs (12 × 8 × 2)→ 64 TXRUs |
| | (4 × 8 × 2) |
| UE Rx Antenna | 2 AEs ports (1 × 1 × 2) |
| # of streams | 2-layer transmission |
| # of beams | 2 per polarization |

It can be observed from each of FIGS. 6A and 6B, that in both Uma and Umi scenarios, the solution proposed by the present disclosure outperforms the “DL GoB” method with 18%˜24% performance gain, indicating their high potentials in the future FDD MIMO products. The proposed “Hybrid KSB GoB CovTrans” has around 3% gain as compared to the EBF variant “UL GSEVD CovTrans” and the “UL KSB GoB CovTrans” that purely based on the uplink measurements approaches the performance of “UL GSEVD CovTrans”.

### Computational Complexity Analysis

In the following, the computational complexity of the present disclosure is evaluated by comparing with different conventional solutions.

The computational complexity of the present disclosure comes from the construction of the beamforming matrix in equation (5) or (6) and the orthogonalization procedure. The computational complexity refers to the number of complex multiplications, and the number of complex additions is trivial and thus neglected. We denote the number of beamforming vectors as r, the matrix dimension as N, and the number of iterations for the power iterative based EVD as J. The computational complexity for the proposed KSB in constructing the beamforming matrix is (r−1)N² and the Gram-Schmidt orthogonalization for r beamforming vectors costs

$$\frac{3 N ( r - 1 ) r}{2} + 2 rN .$$

Table 1 shows the complexity calculation for GSEVD and KSB methods.

TABLE 1
Computational complexity analysis

| | Computational Complexity (# of complex multiplications) |
|---|---|
| GSEVD | ${C}_{GSEVD} = \frac{3 N ( r - 1 ) r}{2} + 2 rN + {JrN}^{2} + J ( \frac{3 N ( r - 1 ) r}{2} + 2 rN )$ |
| KSB | ${C}_{KSB} = ( r - 1 ) {N}^{2} + ( \frac{3 N ( r - 1 ) r}{2} + 2 rN )$ |

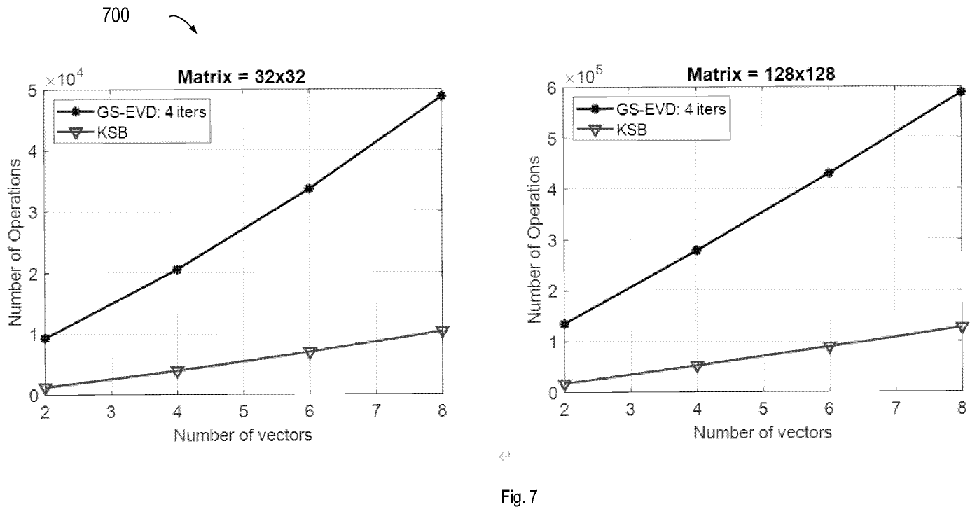

FIG. 7 illustrates the computational complexity curves of different schemes as a function of the number of beamforming vectors, where the iteration number for GSEVD is fixed as 4. It can be observed that the KSB has a much lower computational complexity, only needs 12%˜18% complexity of GSEVD.

### Example Methods

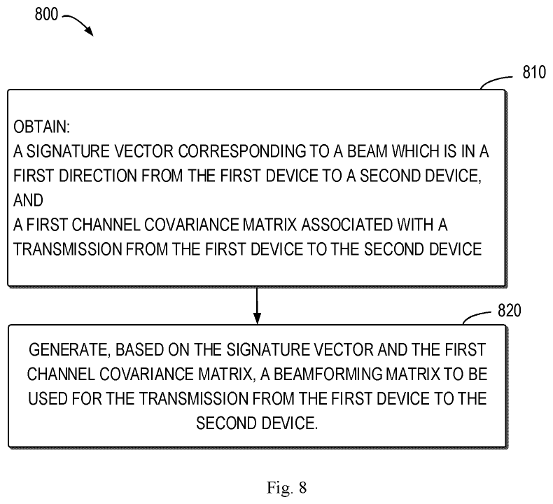

FIG. 8 shows a flowchart of an example method 800 implemented at a first device 210 in accordance with some example embodiments of the present disclosure. For the purpose of discussion, the method 800 will be described from the perspective of the first device 210 with respect to FIG. 2.

At block 810, the first device 210 obtains: a signature vector corresponding to a beam which is in a first direction from the first device 210 to a second device 220, and a first channel covariance matrix associated with a transmission from the first device 210 to the second device 220.

At block 820, the first device 210 generates, based on the signature vector and the first channel covariance matrix, a beamforming matrix to be used for the transmission from the first device 210 to the second device 220.

In some example embodiments, the first device 210 receives information about a dominant beam in the first direction from the second device 220, and obtains the signature vector based on the indicated dominant beam.

In some example embodiments, the information about the dominant beam is an index of the dominant beam.

In some example embodiments, the first device 210 obtains the signature vector from a plurality of pre-defined codebooks based on first channel covariance matrix.

In some example embodiments, the first device 210 receives a reference signal from the second device 220, determines a second channel covariance matrix based on the reference signal, calculates an angular power spectrum based on the second channel covariance matrix, determines a dominant angle based on the angular power spectrum; and obtains the signature vector based on the dominant angle.

In some example embodiments, the first device 210 receives a RS from the second device 220, determines a second channel covariance matrix based on the RS and obtains the first channel covariance matrix by transforming the second channel covariance matrix.

In some example embodiments, the first device 210 compensates, to the second channel covariance matrix, a frequency duplex distance between the first direction and a second direction from the second device 220 to the first device 210.

In some example embodiments, the first device 210 is a network device and the second device 220 is a terminal device.

In some example embodiments, a first apparatus capable of performing any of the method 800 (for example, the first device 210) may comprise means for performing the respective operations of the method 800. The means may be implemented in any suitable form. For example, the means may be implemented in a circuitry or software module. The first apparatus may be implemented as or included in the first device 210.

In some example embodiments, the first apparatus comprises: means for obtaining: a signature vector corresponding to a beam which is in a first direction from the first apparatus to a second apparatus, and a first channel covariance matrix associated with a transmission from the first apparatus to the second apparatus; and means for generating a beamforming matrix to be used for the transmission from the first apparatus to the second apparatus based on the signature vector and the first channel covariance matrix.

In some example embodiments, the means for obtaining the signature vector comprises: means for receiving, from the second apparatus, information about a dominant beam in the first direction; and means for obtaining the signature vector based on the indicated dominant beam.

In some example embodiments, the information about the dominant beam is an index of the dominant beam.

In some example embodiments, the means for obtaining the signature vector comprises: means for obtaining the signature vector from a plurality of pre-defined codebooks based on first channel covariance matrix.

In some example embodiments, the means for obtaining the signature vector comprises: means for receiving a reference signal from the second apparatus; means for determining a second channel covariance matrix based on the reference signal; means for calculating an angular power spectrum based on the second channel covariance matrix; means for determining a dominant angle based on the angular power spectrum; and means for obtaining the signature vector based on the dominant angle.

In some example embodiments, the means for obtaining the first channel covariance matrix comprises: means for receiving a reference signal from the second apparatus; means for determining a second channel covariance matrix based on the reference signal; and means for obtaining the first channel covariance matrix by transforming the second channel covariance matrix.

In some example embodiments, the means for transforming the second channel covariance matrix comprises: means for compensating, to the second channel covariance matrix, a frequency duplex distance between a first direction from the first apparatus to the second apparatus and a second direction from the second apparatus to the first apparatus.

In some example embodiments, the first apparatus a network apparatus and the second apparatus is a terminal apparatus.

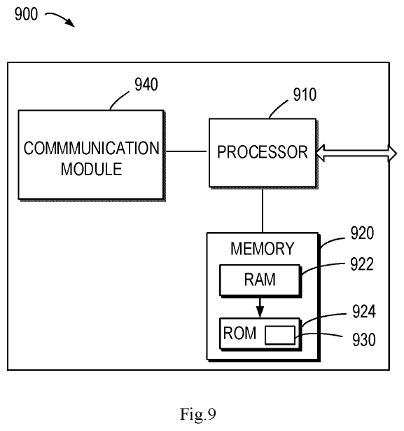

FIG. 9 is a simplified block diagram of a device 900 that is suitable for implementing embodiments of the present disclosure. The device 900 may be provided to implement a first device or a second device, for example the first device 210 or the second device 220 as shown in FIG. 2. As shown, the device 900 includes one or more processors 910, one or more memories 920 coupled to the processor 910, and one or more communication modules 940 (such as, transmitters and/or receivers) coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2 to 5 and 8. The embodiments of the present disclosure may also be implemented by hardware or by a combination of software and hardware.

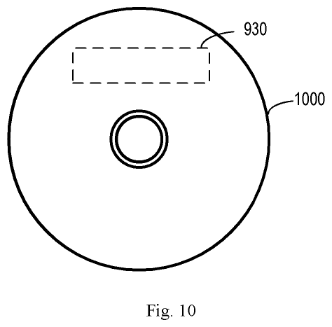

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 800 as described above with reference to FIG. 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program code,
the at least one memory and the computer program code configured to, with the at least one processor, cause the first device to:
obtain:
a signature vector corresponding to a beam which is in a first direction from the first device to a second device, and
a first channel covariance matrix associated with a transmission from the first device to the second device; and
generate, based on the signature vector and the first channel covariance matrix, a beamforming matrix to be used for the transmission from the first device to the second device.

2. The first device of claim 1, wherein the first device is caused to obtain the signature vector by:
receiving, from the second device, information about a dominant beam in the first direction; and
obtaining the signature vector based on the indicated dominant beam.

3. The first device of claim 2, wherein the information about the dominant beam is an index of the dominant beam.

4. The first device of claim 1, wherein the first device is caused to obtain the signature vector by:
obtaining the signature vector from a plurality of pre-defined codebooks based on first channel covariance matrix.

5. The first device of claim 1, wherein the first device is caused to obtain the signature vector by:
receiving a reference signal from the second device;
determining a second channel covariance matrix based on the reference signal;
calculating an angular power spectrum based on the second channel covariance matrix;
determining a dominant angle based on the angular power spectrum; and
obtaining the signature vector based on the dominant angle.

6. The first device of claim 1, wherein the first device is caused to obtain the first channel covariance matrix by:
receiving a reference signal from the second device;
determining a second channel covariance matrix based on the reference signal; and
obtaining the first channel covariance matrix by transforming the second channel covariance matrix.

7. The first device of claim 6, wherein the first device is caused to transform the second channel covariance matrix by
compensating, to the second channel covariance matrix, a frequency duplex distance between the first direction and a second direction from the second device to the first device.

8. The first device of claim 1, wherein the first device is a network device and the second device is a terminal device.

9. A method comprising:
at a first device, obtaining:
a signature vector corresponding to a beam which is in a first direction from the first device to a second device, and
a first channel covariance matrix associated with a transmission from the first device to the second device; and
generating, based on the signature vector and the first channel covariance matrix, a beamforming matrix to be used for the transmission from the first device to the second device.

10. The method of claim 9, wherein obtaining the signature vector comprises:
receiving, from the second device, information about a dominant beam in the first direction; and
obtaining the signature vector based on the indicated dominant beam.

11. The method of claim 10, wherein the information about the dominant beam is an index of the dominant beam.

12. The method of claim 9, wherein obtaining the signature vector comprises:
obtaining the signature vector from a plurality of pre-defined codebooks based on first channel covariance matrix.

13. The method of claim 9, wherein obtaining the signature vector comprises:
receiving a reference signal from the second device;
determining a second channel covariance matrix based on the reference signal;
calculating an angular power spectrum based on the second channel covariance matrix;
determining a dominant angle based on the angular power spectrum; and
obtaining the signature vector based on the dominant angle.

14. The method of claim 9, wherein obtaining the first channel covariance matrix comprises:
receiving a reference signal from the second device;
determining a second channel covariance matrix based on the reference signal; and
obtaining the first channel covariance matrix by transforming the second channel covariance matrix.

15. The method of claim 14, wherein transforming the second channel covariance matrix comprises:
compensating, to the second channel covariance matrix, a frequency duplex distance between a first direction from the first device to the second device and a second direction from the second device to the first device.

16. The first device of claim 9, wherein the first device is a network device and the second device is a terminal device.

17. (canceled)

18. A non-transitory computer readable medium comprising program instructions which, when executed by a first apparatus, cause the first apparatus to perform:
obtaining a signature vector corresponding to a beam which is in a first direction from the first apparatus to a second apparatus; and
obtaining a first channel covariance matrix associated with a transmission from the first apparatus to the second apparatus; and
generating, based on the signature vector and the first channel covariance matrix, a beamforming matrix to be used for the transmission from the first apparatus to the second apparatus.
